(19) United States
(12) Patent Application Publication
(10) Pub. No.: US 2017/0053250 A1
(43) Pub. Date: Feb. 23, 2017

(54) MOBILE METHOD FOR PREPARING VEHICLE TOWING FEES

(71) Applicant: Julian Bowers, Richmond, VA (US)

(72) Inventor: Julian Bowers, Richmond, VA (US)

(21) Appl. No.: 15/241,003

(22) Filed: Aug. 18, 2016

Related U.S. Application Data
(60) Provisional application No. 62/206,811, filed on Aug. 18, 2015.

(51) Int. Cl. G06Q 20/10

(52) U.S. Cl. CPC G06Q 20/102; G06Q 50/26

(57) ABSTRACT

A method to prevent an incorrectly parked vehicle from being towed to an impound lot, wherein tow truck drivers send tow notification warnings to registered users/car owner/driver through a mobile application and the registered users/car owner/driver can pay towing fee in advance while allowing them a set amount of time to also physically claim their vehicle and move to an all-right parking location.

### RELATED APPLICATIONS

This application claims priority from and incorporates by reference U.S. Provisional Patent Application 62/206,811 filed on Aug. 18, 2015.

### FIELD OF THE INVENTION

The invention relates to a method for allowing car owners/drivers to prepay towing fees for vehicles being towed (consensual and/or non-consensual) via a mobile application. The invention also relates to a mobile application for paying vehicle parking tickets & non-consensual towing violation tickets in which the car owner has parked illegally/on private property/obstructing traffic or in any such manner their vehicle must be removed from one location to another without their consent requiring them to pay a/any fee to reclaim their motor vehicle.

### BACKGROUND OF THE INVENTION

When a Car Owner/Driver's motor vehicle is removed from its current location non-consensually due to any parking infraction/violation it is a rather unexpected, unstructured and typically unpleasant experience. The first thought is often that the vehicle has been stolen. Vehicles are not in the police system as being towed to an impound lot until they have been processed at the towing company's physical location. This creates a gap in time of causing immense emotional stress to the car owner/driver as they naturally think their vehicle has been stolen. Once determined the vehicle has been towed it needs to be found (specific impound lot location) and retrieved which are typically unstructured, unplanned and unpleasant activities. The car owner/driver then must either inconvenience someone else in order to get a free ride to the impound or pay a transportation fare (via taxi, Uber, Lyft,etc.) to the impound adding to the costs associated with having their vehicle towed.

### BRIEF SUMMARY OF THE INVENTION

Thus, it is an object of the instant invention to provide a structured solution for both the tow truck company/driver and car owner for vehicles that are being towed or about to be towed. The car owner/driver does not have to go through the emotional stressors associated with the traditional/current methods of retrieving their vehicle. The car owner keeps possession of the vehicle reducing emotional stress, reduce costs associated with towing process (not having to pay taxi/transportation fare), and never becomes unexpectedly stranded. Tow truck companies/drivers also benefit from this method. They reduce operational costs by not having to travel to and from the impound lot for each tow, tow more vehicles per hour, maximize storage lot capacity, and increase tow truck operator safety. This is all the result of allowing the car owner/driver to pay their fine through the mobile app, claim their vehicle physically on site/near infraction, and move their vehicle to an all right location within a set time limit.

An object of the invention is achieved by a method to prevent an incorrectly parked vehicle from being towed, the method including the steps entering characteristic information about an incorrectly parked vehicle and location information of the incorrectly parked vehicle into an application residing on a first data processing device; transmitting the characteristic information and the location information to a database residing on a second data processing device and including member vehicles registered with the application; transmitting membership information of the incorrectly parked vehicle from the second data processing device to the first data processing device; transmitting tow information including the location information from the second data processing device to a third data processing device if the incorrectly parked vehicle is a member vehicle; transmitting payment information from the third data processing device to the second data processing device if the incorrectly parked vehicle is a member vehicle and a member wishes to advance towing fees; transmitting a no tow confirmation from the second data processing device to the third data processing device if the towing fees are advanced; and transmitting a no tow confirmation from the second data processing device to the first data processing device if the towing fees are advanced.

The application performs the following functions:

Notifies users regarding their car is soon to be towed or is being towed.

Provides a timer to remove the car.

Provides location of impound lot where the car has been towed.

Provides record of all the parking tickets gathered post registration.

Notifies a tow truck driver whether to tow a car immediately or wait for the owner to remove it.

Provides a one-stop solution for paying parking tickets.

The application will work on iOS 7 and above, on iPhone 4S and later, and on any other suitable application platform. The application may be implemented on a processing device like a mobile phone, an ipad, etc. The application may have a Google or Facebook sign up plugin along with an Uber and Google Maps API. If the vehicle is towed the route and time will be sent to the owner

The inclusion of Uber/Lyft, for example, allows for targeted advertising of alternative transportation for those who have had their cars towed.

The clients for the application include drivers, tow truck companies and tow truck drivers.

When a tow truck driver is assigned a tow truck with a phone he/she opens the application and a welcome screen appears with a login screen. The driver enters his/her login details (e.g., driver id and password) and the same is confirmed from the server. Driver details are reflected for double verification. After the driver details are properly entered, the camera is enabled for the driver to capture the license plate of the tow truck assigned to him. The license plate number is verified with the server and only after this, the driver can start his job. After the license plate number verification, a start job screen appears with a button for the driver to enable the camera.

When the tow truck driver identifies a vehicle in a no-parking zone/private parking zone, he uses the mobile app camera button/or hard enters license plate, an image of the license plate is captured and sent to the server, where the server matches the license plate number with the one in its database. If the license plate number is in the server, the owner of the car is notified their vehicle is being towed and the timer is triggered, the tow truck driver waits for the set amount of time the tow company allows for the driver to collect the vehicle & time allowed to car owner/driver to pay via the mobile app. If the license plate number is not in the server, the tow truck driver is notified regarding the same and the driver takes the vehicle to the impound lot per the traditional method of towing.

If the user has responded to the notification, the tow truck drive driver gets a notification regarding the same and waits for the user to appear and remove the vehicle. The tow truck driver then gets a screen on the application with buttons (Claim or no show). Claim means the owner shows up and removes the vehicle and no show is when the owner fails to show up to remove the vehicle within the set grace period.

If the user appears after responding, the tow truck driver hits the claim button on the mobile app the same is reflected on the server and the necessary details regarding the parking ticket are entered in the records. If the user, i.e. car owner/driver doesn't show up after responding, the tow truck driver hits the no show button on the app, a notification is sent to the owner regarding the same and the same is reflected in the record along with the details of the impound lot where the car is being towed. The user is given directions regarding the impound lot with the help of Google maps [API] & also message from Uber/Lyft etc asking if they need a ride to the current location of their vehicle.

The user logs in and registers as follows: Password fields appear along with a button for new user to sign up. If the user is already registered he can use his registered email id as username to log into the application. If the user is not registered, He can use the sign up button to be a user of the application.

For registering the user has two options: Enter details on his own or retrieve details from Facebook/Google or the like. Once the basic information is taken from any of the above-mentioned ways the car details of the user are taken from the user. After the details are registered, the camera is enabled wherein the user captures the license plate of the car and the license plate number is linked with the user profile and is saved in the server.

When a registered car is scheduled to be towed a user gets a vibration and sound alert along with push notification on the screen of a mobile data processing device. The timer triggers as soon as the notification is displayed on the user's device. The user can respond to the push notification with a slide action. Once the user responds to the notification, the pay button along with the location display appears. The app tracks the location of the user/car owner/driver and the car that is about to be towed as the tow truck driver is at that current location, and shows the estimated time to reach the car. If the car can be reached within the set period of time allotted, then only the pay button appears. If the user owner can't be reached within the grace period, then the pay but tow button appears wherein the user pays the penalty but the car is towed and the details of the impound lot are displayed or the car owner/driver can request additional time for a fee. If the user doesn't respond to the notification within the grace period, a notification regarding the tow is displayed & the vehicle is towed to the impound lot. The user then enters the app and is displayed all the details regarding the impound lot along with the tow time, route the vehicle traveled, and location is displayed. The user gets to pay the penalty and the towing fees beforehand from the app itself and can then go and pick up the vehicle from the location if they choose the course of action.

When a new tow truck driver is assigned to a towing job the driver needs to sign up his/her account on the application. Once the driver is signed in the application then his/her account should go through an approval process. This is set up by the towing company with the phone they assign to each tow truck driver.

Once the tow truck driver gets the account approval, he can start using the application. On the login page tow truck companies will have an access key for new tow truck drivers.

Whenever the driver or a law enforcement official sees a parked car in an inappropriate location (Private Parking/No parking zone) they walk to the car and take an image of car's number plate (license plate) through the application and once the image is submitted to the application automatically sends push notification to a registered owner that his/her car is in the process of being towed but is currently parked at same position where the user left the car. A user is notified as described supra and now has the option to pay fees due and claim the vehicle in the allotted grace period.

If the car in violation is not registered in the application database a message is sent immediately notifying the tow truck driver and instructs the driver to tow the vehicle to the impound lot immediately.

Once a tow truck driver submits a license plate photo (scans the license plate using the No Tow application), the grace period starts (once the vehicle is confirmed REGISTERED with No Tow) the set allotted time automatically appears on the tow truck driver application page and in notification sent to car owner.

The tow truck driver does not have to do any work other that just scan the license plate and hook the vehicle up. Confirmation of payment is automatically and instantaneously sent to the tow truck driver and the towing company that driver works for. If the car owner arrives within the set time the tow operator will drop/release the vehicle.

Once confirmation of payment is received and car owner physically present then the tow truck driver can release the car. In order to do so the user has to be at the location and has to move their car immediately. If they have paid the penalty and are a ‘no show’ to claim their vehicle before the allotted time runs out, then the vehicle is towed to the impound lot where they can come and claim their vehicle.

After the grace period timer stops, the Tow Truck driver has two buttons on the page 1) Release Car 2) or Car Towed finally (Car Owner No Show Proceeding to Impound Lot), something along those lines.

Once Car Towed Finally button presses driver has Car left at station button.

Driver has logout feature available on the application. —Driver should not have to log in/out for each tow. ‘New Vehicle’ or ‘Next Job’ button.

Car owner or driver is able to sign up for this application through their mobile device and register the vehicle and thus become a user of the application.

When a user's vehicle is in the process of being towed, the user gets an alert (Push Notification that rings vibrates/screen lights up/something discreet but is sure to grab their attention) on an application window that his/her car is about to be towed to the IMPOUND lot and a grace period timer will automatically start and a message will appear on the timer. For Example, “Please go to vehicle within 2 minutes” “Please PAY NOW & Claim Vehicle before grace period expires”.

Under timer the user has a Pay Now button. As soon as the ‘Pay Now’ button is pressed, the user's credit card on file is immediately charged for the set rate shown.

Once a car is towed, the user/Car Owner/Driver can see the current location of the car position and if the car has been left at a tow impound lot the user can see the location and shortest path to get there. The goal is to not tow the vehicle to the impound lot but if it does get towed, the owner is provided with the location of the impound lot and has the opportunity to pay all fees through the application. The vehicle will then be released to the user at the impound lot upon his arrival at the impound lot.

UBER/Lyft/All taxi allowable service APIs will be tied in offering the user a ride to their vehicle at the impound lot. Car Owner can use logout feature available on the application.

The application can also be used for paying car insurance and other car related fines and expenses like maintenance bills and bills at gas stations.

A timer is provided on both screens, e.g., on the tow truck driver screen and the user screen because if the user is around and if he/she is able to reach the vehicle within the grace period, then tow truck driver will not tow the vehicle but the user must pay the penalty and remove the vehicle within the grace period/allotted time. If the user can't reach to car within the grace period then tow truck driver will tow the vehicle to the impound lot.

### BRIEF DESCRIPTION OF THE DRAWINGS

Advantageous embodiment of the invention with additional configurative details and additional advantages are subsequently described with reference to the appended drawing figures, wherein

FIG. 1 illustrates a schematic diagram of the function interrelating elements of the application;

FIG. 2 illustrates an overview of the various screens of the application;

FIG. 3 illustrates the welcome screen of the application;

FIG. 4 illustrates the start screen of the application;

FIG. 5 illustrates the tow warning screen of the application;

FIG. 6 illustrates the entry screen for tow truck drivers or law enforcement officials;

FIG. 7 illustrates a license plate image taken by a tow truck driver or law enforcement official;

FIG. 8 illustrates a timer screen after penalty has been paid;

FIG. 9 illustrates a screen where the user can communicate with the tow truck driver;

FIG. 10 illustrates a screen showing executed payments to the user and the tow truck driver;

FIG. 11 illustrates an information entry screen for the user;

FIG. 12 illustrates a user screen showing grace period timer and claim/no show buttons;

FIG. 13 illustrates pay and tow and pay and wait selection screens for the user;

FIG. 14 illustrates a screen showing location of impound lot of towed car; and

FIG. 15 illustrates a sequential flow chart for the method according to the invention; and

FIG. 16 illustrates key features of the invention.

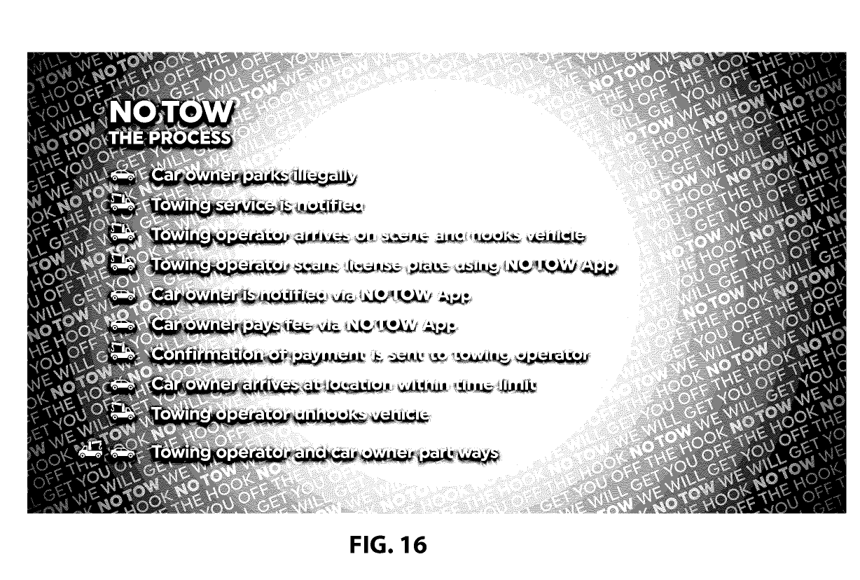

### DETAILED DESCRIPTION OF THE INVENTION

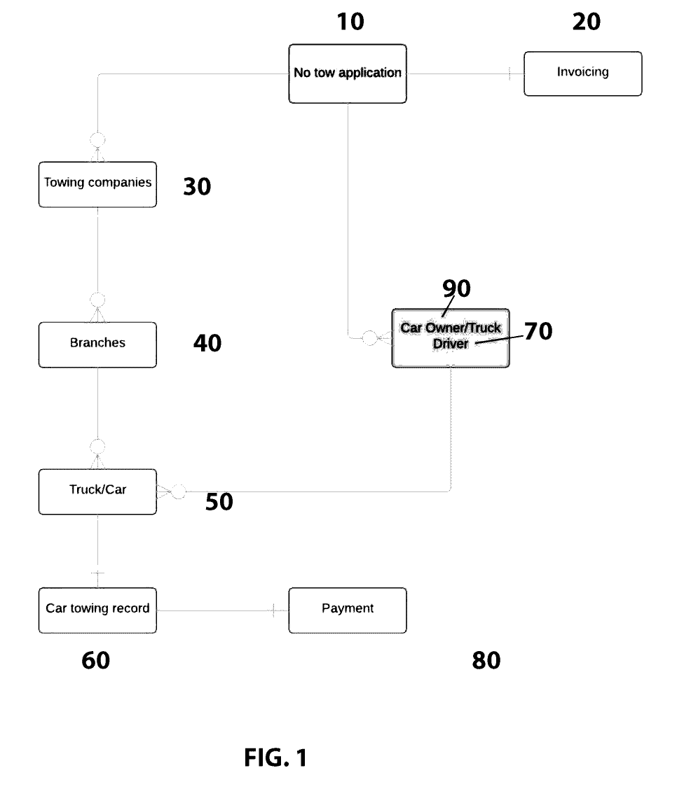

FIG. 1 illustrates elements that are information interlinked by the application. An invoicing function 20 is controlled by the application 10. Towing companies 30 with their branches 40 and their tow trucks are information linked with the application. Car owners or users 90 and tow truck drivers 70 are information linked with the application. A car towing record 60 and a payment record 80 are controlled by the application.

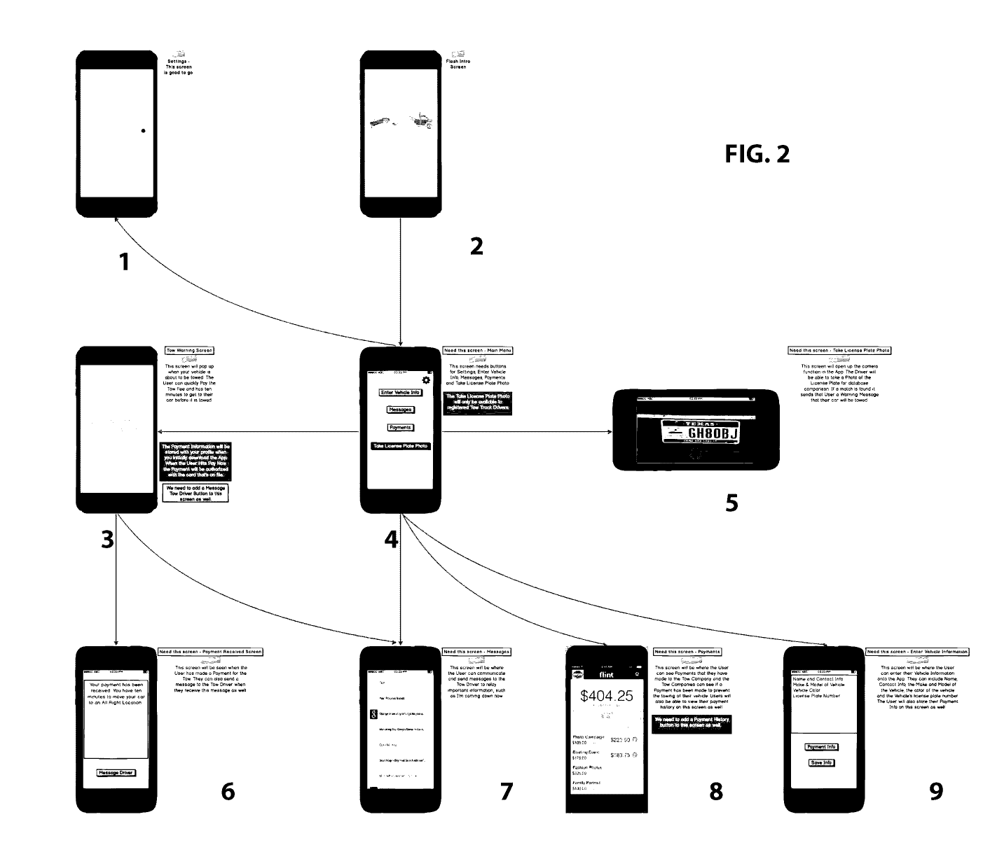

FIG. 2 illustrates an overview of the different application screens 1-9 and they are information linked. The respective function and the information linking is described in a separate figure for each application screen.

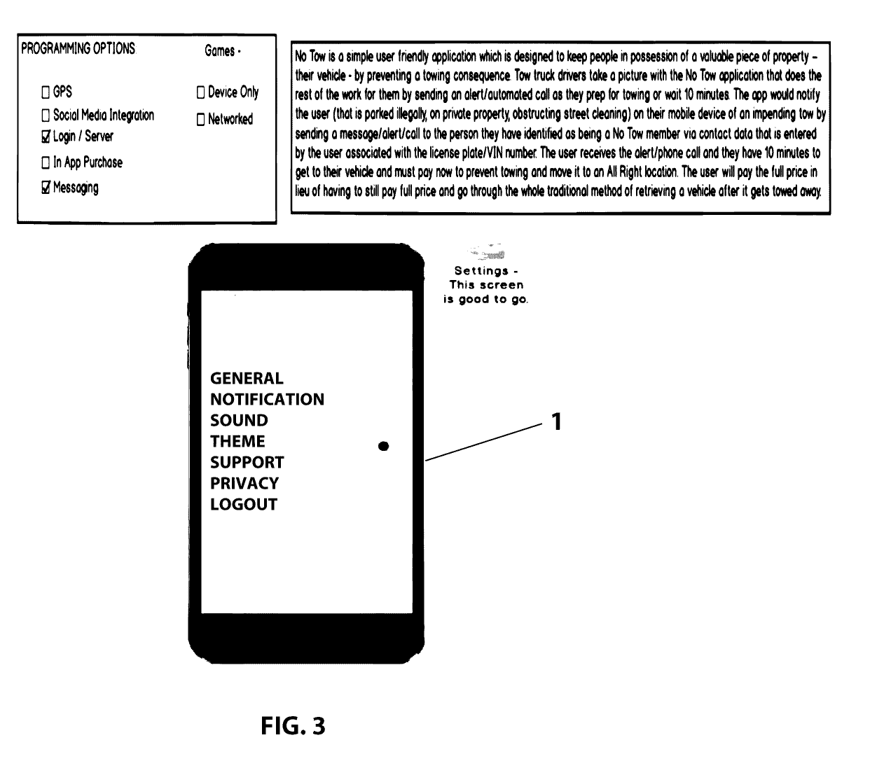

FIG. 3 illustrates the welcome screen of the application with a switch to turn notifications from the application on and off and a slide to control sound levels from the application.

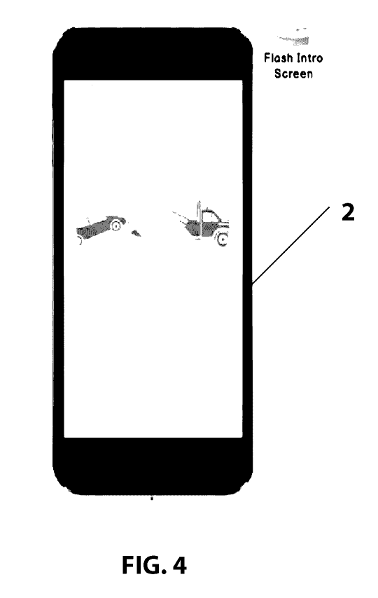

FIG. 4 illustrates a flash intro screen of the application with the application logo.

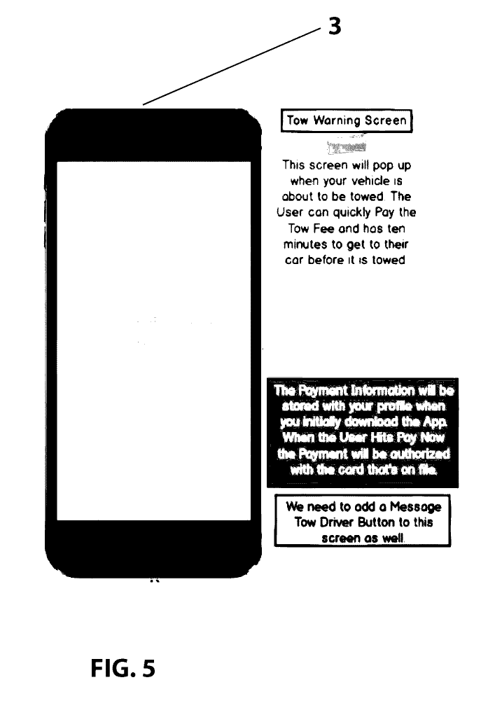

FIG. 5 illustrates a tow warning screen. The vehicle has been spotted in a tow away location by a law enforcement official or by a tow truck driver. The law enforcement official or the tow truck driver has taken an image of the license plate and sent it to the application from his mobile data processing device or has entered the license plate number manually into his mobile data processing device. The user has the option to pay the towing charge and the penalty within a preset grace period, e.g. pay within 2 minutes and be at the vehicle within 5 minutes of receiving the tow warning message. The location of the vehicle or the location of the mobile device of the law enforcement official is displayed to the user on his screen and the location of the mobile device of the user is displayed on the screen of the mobile data processing device of the law enforcement official. This indicates to the user if he can get to the vehicle within the grace period and it indicates to the law enforcement official if the user can get to the vehicle within the grace period. A tow truck driver has an incentive to wait for the user because he has already been paid and does not have to tow the vehicle any more if the user removes the vehicle from the towing location within the grace period.

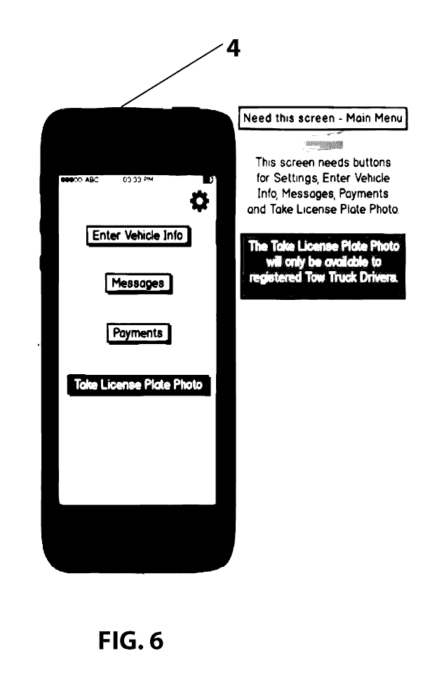

FIG. 6 illustrates a data entry screen for the user and a tow truck driver or law enforcement official. The user enters the license plate number manually or by taking a picture of the license plate. The user enters name, residence and payment information. The law enforcement official or tow truck driver enters the license plate number manually or takes a picture of the license plate number. The mobile data processing device of the law enforcement official captures location information and sends it to the application together with the vehicle identification information.

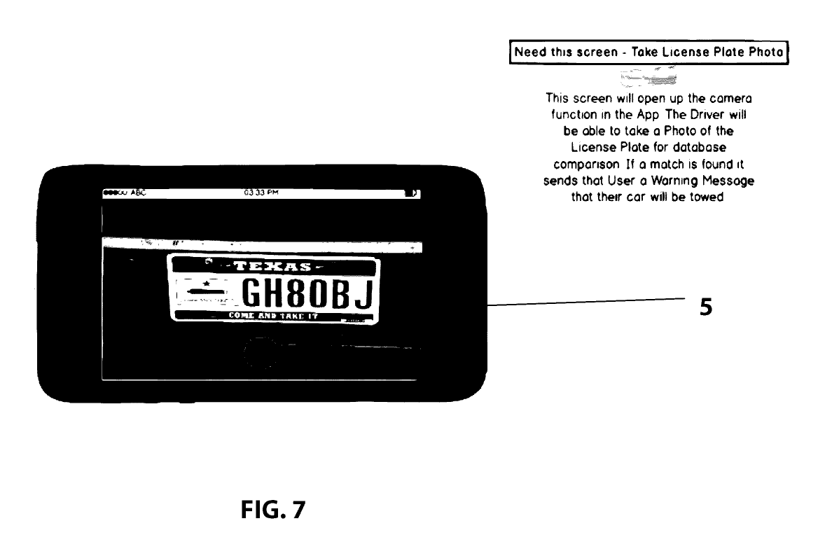

FIG. 7. Illustrates the screen that a tow truck driver sees when he takes images of a license plate.

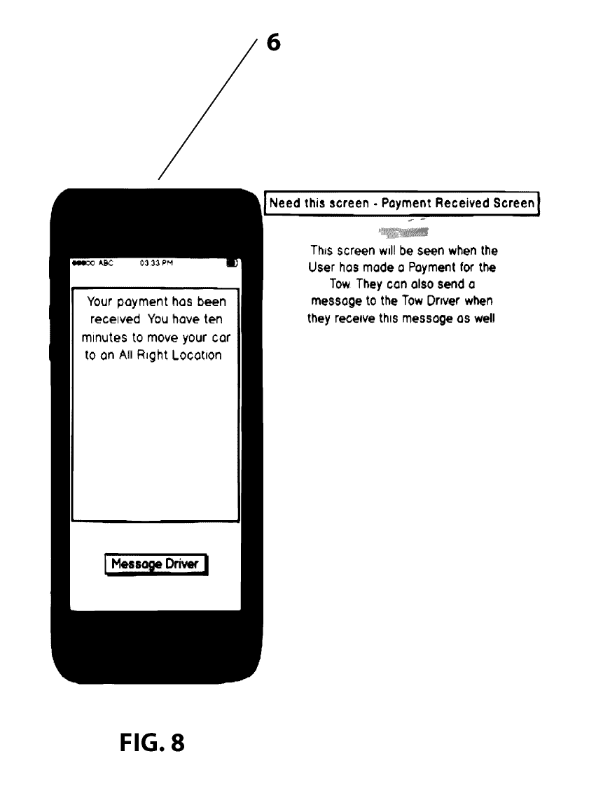

FIG. 8 illustrates the screen that the user sees when payment has been received the screen. The screen shows the grace period, in this case 10 minutes that is available to the user to remove the vehicle.

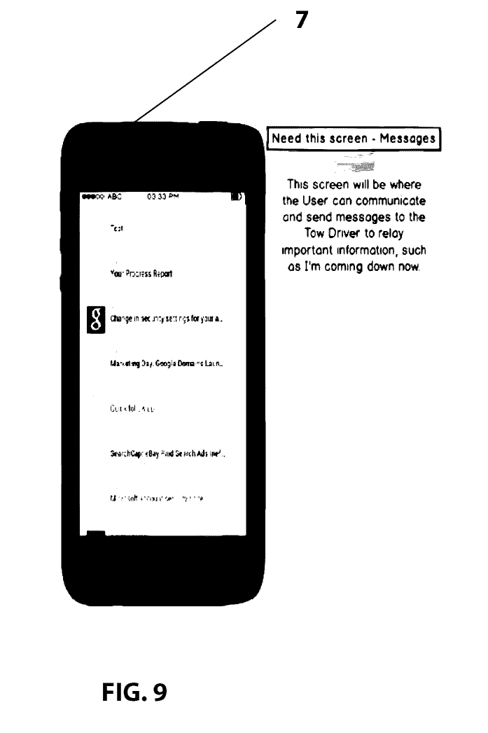

FIG. 9 illustrates the screen that is available to the user to communicate with the tow truck driver, most important to announce to the tow truck driver that user is coming immediately to remove the vehicle.

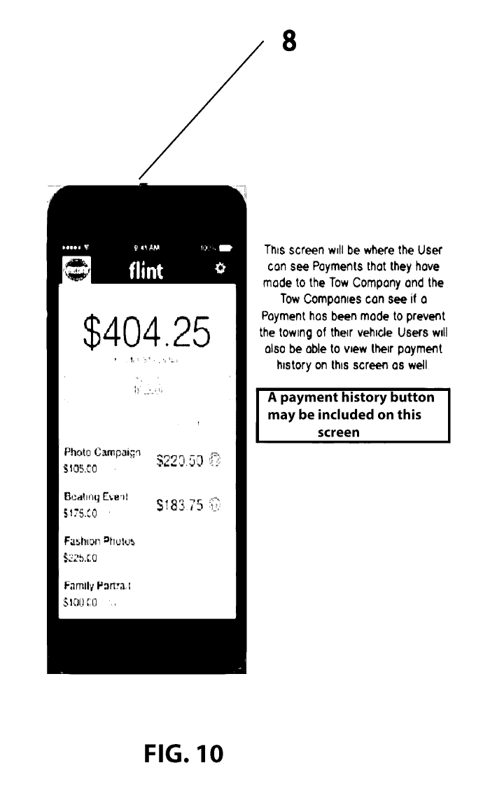

FIG. 10 shows the screen where the user can see that payment has been executed and where the towing company can see that payment has been received.

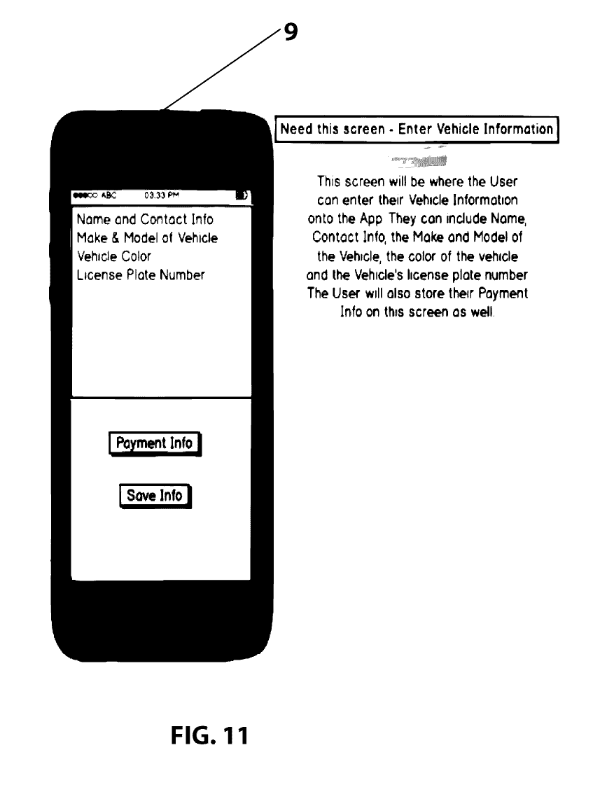

FIG. 11 illustrates the screen where a user can enter name, contact information and vehicle information like a license plate number.

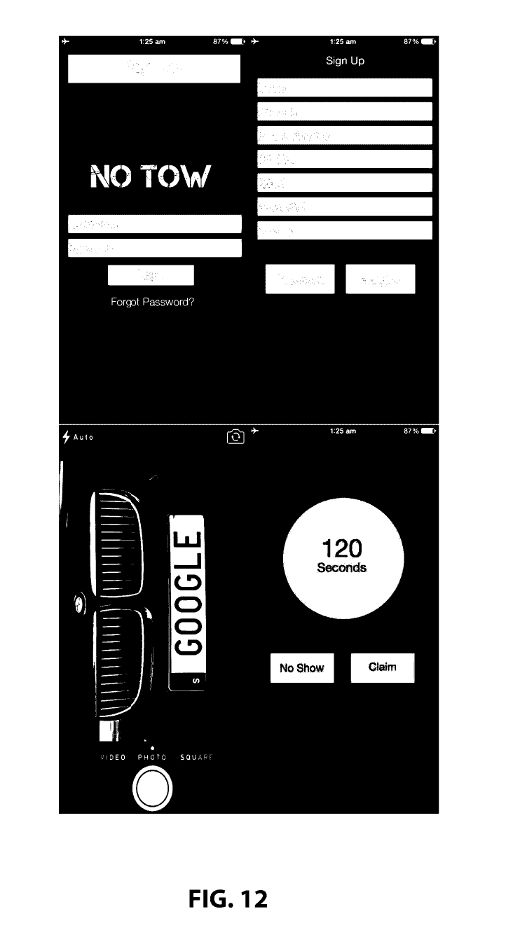

FIG. 12 illustrates a screen where the user sees a shot taken my a tow truck driver or a law enforcement official showing the license plate, the grace period to pay and to claim the vehicle.

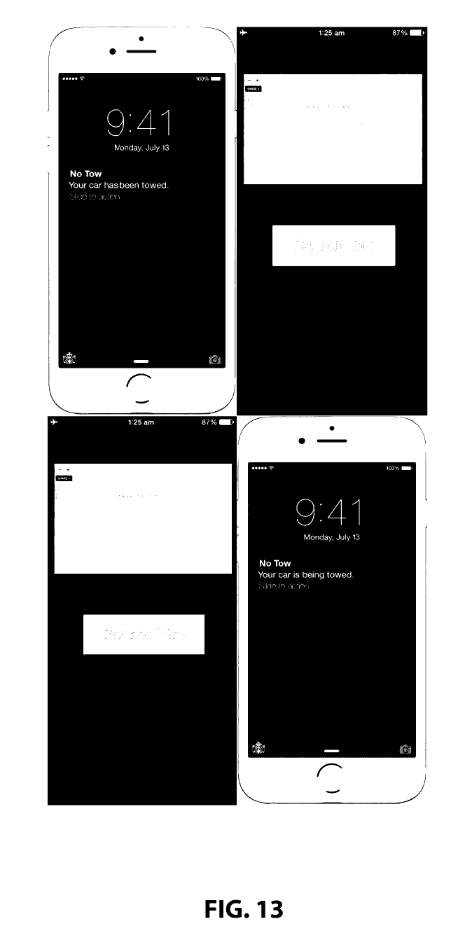

FIG. 13 top left shows a screen that is visible to the user after the vehicle has been towed. Operating the slide on the top left screen moves to the top right screen that shows the location of the impound lot and gives the option to pay the fees so the car can be picked up at the impound lot without further delays and formalities.

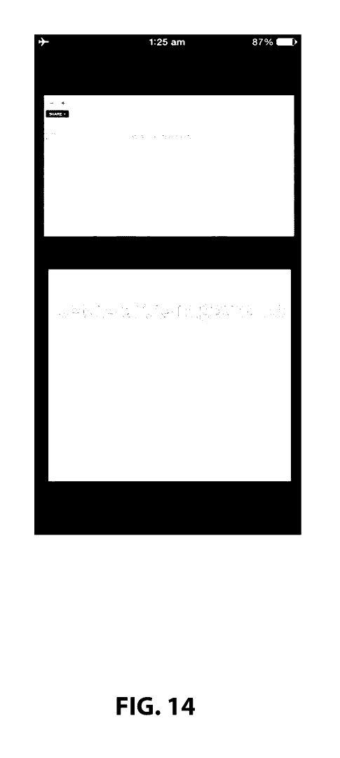

FIG. 14 illustrates a screen that shows the location of the impound lot where the car has been towed.

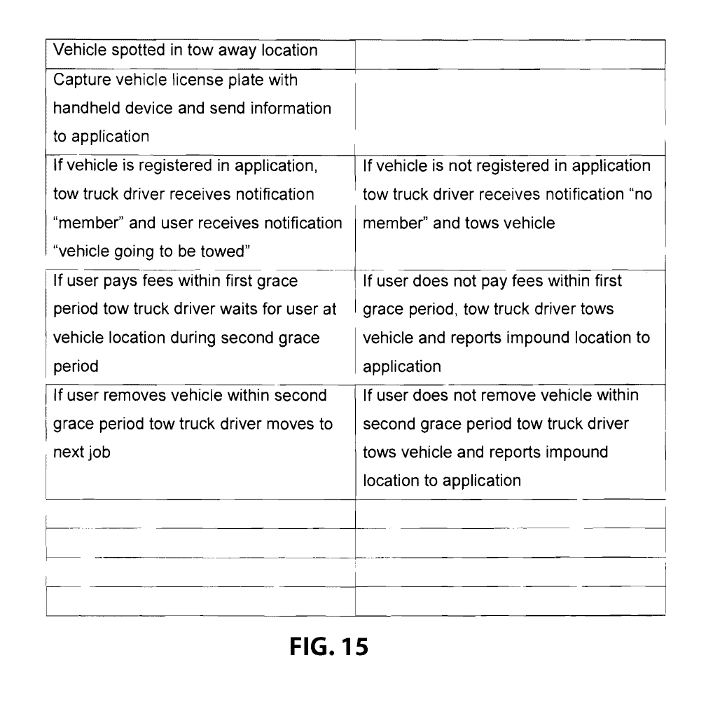

FIG. 15 illustrates a sequential flow chart of the process according to the invention.

### REFERENCE NUMERALS AND DESIGNATIONS

10 no tow application

20 invoicing function

30 towing company

50 tow truck

60 car towing record

70 tow truck driver

80 payment

90 user

What is claimed is:

1. A method to prevent an incorrectly parked vehicle from being towed, the method comprising the steps:
entering identifying information about an incorrectly parked vehicle and location information of the incorrectly parked vehicle into an application residing on a first data processing device;
transmitting the identifying information and the location information to a database residing on a second data processing device and including member vehicles registered with the application;
transmitting membership information of the incorrectly parked vehicle from the second data processing device to the first data processing device;
transmitting tow information including the location information from the second data processing device to a third data processing device if the incorrectly parked vehicle is a member vehicle;
transmitting payment information from the third data processing device to the second data processing device if the incorrectly parked vehicle is a member vehicle and a member wishes to advance towing fees;
transmitting a no tow confirmation from the second data processing device to the third data processing device if the towing fees are advanced; and
transmitting a no tow confirmation from the second data processing device to the first data processing device if the towing fees are advanced.

2. The method according to claim 1,
wherein the identifying information includes an image of a license plate of the incorrectly parked vehicle, or
wherein a license plate number of the incorrectly parked vehicle is entered manually as the characteristic information.

3. The method according to claim 1, wherein the identifying information is entered by a law enforcement official.

4. The method according to claim 1, wherein the identifying information is entered by a tow truck operator.

5. The method according to claim 1, wherein the no tow confirmation includes a no tow grace period.

6. The method according to claim 1, wherein the location information of the incorrectly parked vehicle entered into the application residing on the first data processing device is determined and entered automatically based upon a global positioning system.

7. The method according to claim 5,
wherein the incorrectly parked vehicle is towed after the towing fees were advanced and the incorrectly parked vehicle has not been removed after an expiration of the no tow grace period, and
wherein information regarding where to retrieve the incorrectly parked vehicle is transmitted from the second data processing device to the third data processing device.

8. The method according to claim 7, wherein the information where to retrieve the incorrectly parked vehicle includes routing information from a location of the third data processing device.

10. A method to prevent an incorrectly parked vehicle from being towed, the method comprising the steps:
entering identifying information about an incorrectly parked vehicle and location information of the incorrectly parked vehicle into an application residing on a first data processing device;
transmitting the identifying information and the location information to a database residing on a second data processing device and including member vehicles registered with the application;
transmitting membership information of the incorrectly parked vehicle from the second data processing device to the first data processing device;
transmitting tow information including the location information from the second data processing device to a third data processing device if the incorrectly parked vehicle is a member vehicle;
transmitting payment information from the third data processing device to the second data processing device if the incorrectly parked vehicle is a member vehicle and a member wishes to advance towing fees,
wherein information regarding where to retrieve the incorrectly parked vehicle is transmitted from the second data processing device to the third data processing device if the towing fees are advanced.

8. The method according to claim 10, wherein the information where to retrieve the incorrectly parked vehicle includes routing information from a location of the third data processing device.

9. The method according to claim 10, wherein the identifying information is entered by a law enforcement official.

10. The method according to claim 10, wherein the identifying information is entered by a tow truck operator.

11. A method for paying violation penalties for an incorrectly parked vehicle, the method comprising the steps:
entering identifying information about an incorrectly parked vehicle and location information of the incorrectly parked vehicle into an application residing on a first data processing device;
transmitting the identifying information and the location information to a database residing on a second data processing device and including member vehicles registered with the application;
transmitting membership information of the incorrectly parked vehicle from the second data processing device to the first data processing device;
transmitting violation information including the location information from the second data processing device to a third data processing device if the incorrectly parked vehicle is a member vehicle;
transmitting payment information from the third data processing device to the second data processing device if the incorrectly parked vehicle is a member vehicle and a member wishes to advance violation penalties;
transmitting a payment confirmation from the second date processing device to the third data processing device if the violation penalties have been advanced.

12. The method according to claim 11, wherein the identifying information is entered by a law enforcement official.
